(19) United States
(12) Patent Application Publication
(10) Pub. No.: US 2016/0175862 A1
(43) Pub. Date: Jun. 23, 2016

(54) ENVIRONMENTALLY FRIENDLY LOW-PRESSURE SPRAY APPARATUS

(71) Applicant: SAN-CHING CHEN, TAIPEI CITY (TW)

(72) Inventor: SAN-CHING CHEN, TAIPEI CITY (TW)

(21) Appl. No.: 14/578,655

(22) Filed: Dec. 22, 2014

(51) Int. Cl. B05B 7/24; F04B 43/04; B05B 7/00

(52) U.S. Cl. CPC B05B 7/2491; B05B 7/0081; F04B 43/04

(57) ABSTRACT

The present invention relates to an environmentally low-power & low-pressured spray apparatus, comprising a very low AC power under 400W or portable DC battery, low-pressured electromagnetic diaphragm pump, combined with a large-diameter connection hose, and then in combination with a special low pressure spray gun. In use of a large amount of air produced by the pump, passing through the connecting big diameter hose to the special low pressure spray gun, the paint or coating can fast and efficiently be atomized and coated on walls or other items, wherein losses of the paint material or coating can be much reduced and the air pollution and noise pollution are also much reduced. Meanwhile, the invention can save the consumption and waste of electricity more than 80%, which is then obtained creative and progressive.

### FIELD OF THE INVENTION

The present invention relates to an environmentally friendly low-pressure spray apparatus, wherein the main advantage is to use a low wattage and low pressure electromagnetic diaphragm pump, which can be driven by very low AC power or portable with DC battery, producing a lot of air passing through a large-caliber hose to a spray gun for transporting the paint or coating, being rapidly and efficiently coated on the wall or other objects, that obtains improvement.

### BACKGROUND OF THE INVENTION

It is known that conventional compressor painting spray equipment usually use at least 3 Hp (2200 W) piston-type high pressure air compressors as spraying power source. When used, the compressor painting spray equipment will produce a great noise and that is quite uncomfortable. And because of its spraying operations being usually higher than 30-50 psi as the discharge pressure is very large, while its use of the connecting tube having a diameter always no greater than 0.6 cm, the spray paint or coating hit the wall at the time that usually a large portion will rebound. It will cause so much mist in the spraying workplace, easily inhaled and cause harm to the human body, while resulting in excessive loss of paint or coating. So those should be improved.

### SUMMARY OF THE INVENTION

The present invention provides an environmentally friendly, low noise, low power (wattage is not higher than 400W), and low-pressure spray apparatus, including a low-voltage electromagnetic diaphragm pump, combined with a large-diameter connecting hose, and then in combination with a special low pressure spray gun. The apparatus utilizes a low power and low pressure pump, which produces large amounts of air through the connecting tube and transported to the special low pressure spray gun, that the paint or coating are capable of being quickly and efficiently atomized and coated on a wall or other items. It can reduce the loss of paint or coating rebound, and reduces air and noise pollution, that is attainable and practical progress.

Now, accompanying with drawings, the character and structure of the present invention will be disclosed as following.

### BRIEF DESCRIPTION OF THE DRAWINGS

FIG. 1 is a perspective view of an environmentally friendly low-pressure spray apparatus according to the present invention.

FIG. 2 is an exploded view of FIG. 1.

### DETAILED DESCRIPTION OF THE PREFERRED EMBODIMENT

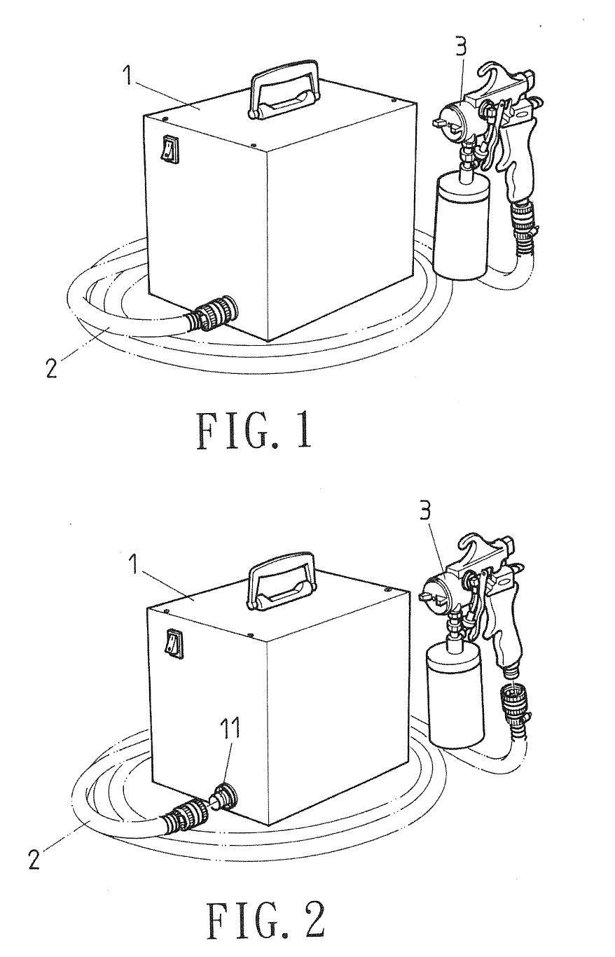

Referring to FIGS. 1 and 2, the present invention relates to an environmentally friendly energy-saving low-pressure spray apparatus, including a low-voltage electromagnetic diaphragm pump (1), which has its one side a combined head (11) to combine one end of a large-diameter connecting hose (2), in which the combination can be used by the screwing or quick connectors, etc. to complete. And the inner diameter of the connecting hose (2) is set to not less than 1.5 cm, in order to prevent the delivery loss of air, and then with the other end to the special low pressure spray gun (3) using the same quick connector screwed or combined to form the overall structure of the present apparatus.

When in use, the present invention utilized of low wattage pump (1) based of low AC power or portable DC battery, low-pressure electromagnetic diaphragm, can produce large amounts of air, and does not issue so big noise as conventional high-pressure piston-type compressor, but actually measured by the number of decibels is not more than 55 dB(A), much lower than a conventional air compressor noise over 100 dB(A). A lot of air through the large-diameter connection hose (2) to the special low pressure spray gun (3) can be effectively atomized paint or coating with the time, is able to be quickly and efficiently coated on a wall or other article. And due to the low discharge air pressure of the invention is no more than about 2-3 psi, most of the paint or coating will be completely attached with the wall or article thereof that can help to reduce the loss of painting material. Hence, the present invention can really reduce the consumption and waste of power and noise pollution, and can reduce bounce waste paint or coating, and to overcome the lack of conventional compressor painting kits. It is therefore attainable creative and progressive for allowance of patent.

Therefore, the present invention obviously obtains improvement and facilitates. And it is to be understood that any modified design according to the merit of the present invention will be still claimed in this application.

1. An environmentally friendly low-pressure spray apparatus comprising a low pressure electromagnetic diaphragm pump, wherein one side is provided with a combined head to connect with a connecting hose, and the other end of the connecting hose is integrally combined with a special low pressure spray gun to allow air to be supplied from the pump through the connecting hose to the spray gun, in which the inner diameter of the connecting tube is at least 1.5 cm such that a discharge air pressure of air flowing through the spray gun is no more than about 2-3 psi.

2. The environmentally friendly low-pressure spray apparatus as claimed in claim 1, wherein the connecting tube has either end combined the electromagnetic diaphragm pump and the special low pressure spray gun with screwed or quick connector with thereof.

3. The environmentally friendly low-pressure spray apparatus as claimed in claim 1, wherein the low pressure electromagnetic diaphragm pump is capable of using low AC power or portable DC battery as power supply.
